(19) United States
(12) Patent Application Publication
(10) Pub. No.: US 2005/0207145 A1
(43) Pub. Date: Sep. 22, 2005

(54) "Cats' heart shape" night light

(76) Inventor: Mark Alan Court, Wheatland, CA (US)

Correspondence Address: Mark Court, 306 3rd Street, Wheatland, CA, 95692, US

(21) Appl. No.: 10/800,789

(22) Filed: Mar. 16, 2004

(51) Int. Cl. F21S 6/00; F21S 13/14

(52) U.S. Cl. 362/124; 362/249; 362/252

(57) ABSTRACT

The technical disclosure is the process of forming (shaping) an electrical light emitting device into an outline of two cats that form a heart shape with their lower bodies, paws and tails along with adding a secondary heart shape inside of the heart shape formed by the cats to complete visual art that is displayed to the human eye with the light emitting device.

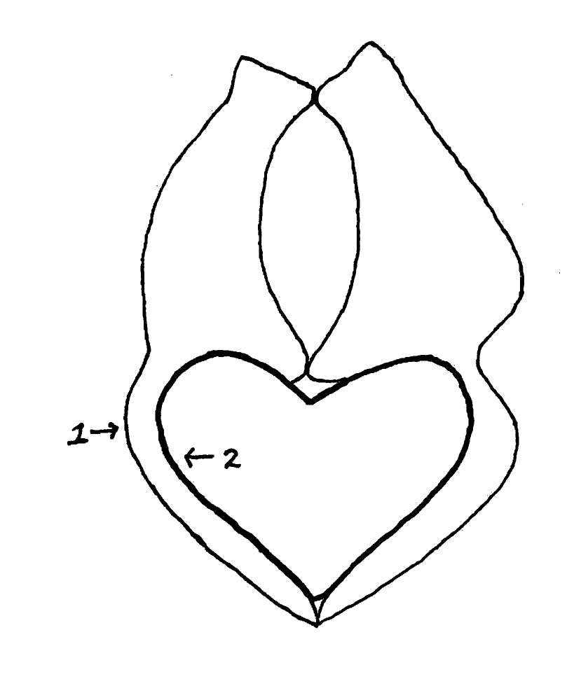

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### CROSS-REFERENCE TO RELATED APPLICATIONS

Not Applicable

### STATEMEN REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

My prototype “Cats' Heart Shape” Night Light can be placed in the field of visual art that is displayed to the human eye with an electrical light emitting device. I used an electrical light source to create visual art (my “Cats' Heart Shape” Night Light) as described later in this specification. Specific documents that are related to my invention are my copyrights for my “Cats' Heart Shape” artistic drawings. The copyright registration numbers are VAu 255-141, VAu 302-171 and VAu 329-080 which are registered with the United States Library of Congress Copyright Office. These registered drawings are similar to the drawing included in this application, but are not exactly the same.

### BRIEF SUMMARY OF THE INVENTION

I used an electrical light emitting device to make my prototype “Cats' Heart Shape” Night Light. I formed an outline with the light emitting device as follows. Two cats were positioned together and their lower bodies, paws and tails were used to form a heart shape. I added extra emphasis to the heart shape formed by the cats by placing a second heart shape inside of the heart shape formed by the cats. By using an electrical light emitting device I created a pleasing artistic night light.

### BRIEF DESCRIPTION OF THE SEVERAL VIEWS OF THE DRAWING

List of sheets:

One (1) drawing—Sheet 1 of 1/Drawing of my “Cats' Heart Shape” Night Light One set of black and white photos of my prototype “Cats' Heart Shape” Night Light

Sheet 1 of 1 shows two cats sitting in an upright position. They are looking at each other and their faces touch as if they are kissing. There lower bodies, paws and tails form the upper portion of a heart shape and their tails extend downward and touch at the bottom to form the lower portion of a heart shape. Inside of the heart shape formed by the cats is a second heart shape (added for extra emphasis).

### DETAILED DESCRIPTION OF THE INVENTION

I made my prototype “Cats' Heart Shape” Night Light by shaping white string lights to form an outline of two cats which are positioned together to form a heart shape with their lower bodies, paws and tails. The distinguishing feature of my invention is the heart shape formed by two cats with their lower bodies, paws and tails and which is displayed to the human eye by using an electrical light emitting device. My prototype “Cats' Heart Shape” Night Light is described in detail as follows. Two cats sitting in an upright position facing (staring) at each other. Their faces touch together around the mouth area and they appear to be kissing. Their paws touch and their lower bodies are positioned to form the upper portion of a heart shape. Their tails project in a downward direction, with each tail forming half of a heart shape. Their tails connect at the bottom. Together their paws, lower bodies and tails form a heart shape. On the drawing submitted (sheet 1 of 1) reference character number one (1) depicts the entire outline of the cats which includes the heart shape formed by the cats and on my prototype white string lights were used for this outline. Reference character number two (2) on the drawing (sheet 1 of 1) depicts the outline of a second (2nd) heart shape placed inside of the heart shape formed by the cats. This second heart shape was intentionally drawn with a thicker line to make it known that a second heart shape is inside of the heart shape formed by the cats. On my prototype red string lights were used to outline this second heart shape which adds extra emphasis to the heart shape formed by the cats. Reference characters one (1) and two (2) on the drawing together embody the entire “Cats' Heart Shape” Night Light. When power is applied, the string lights radiate soothing relaxing colors and my “Cats' Heart Shape” Night Light is materialized. Included in this application is one set of photographs to show more clearly (illustrate) my prototype “Cats' Heart Shape” Night Light.

Making and using it. My prototype “Cats' Heart Shape” Night Light was made by shaping electrical light into a form (outline) of two cats as described in this description (as shown in the drawing and the photos). I used string lights on my prototype, but any light emitting source (device) such as neon light tubing, fiber optics, Christmas lights, string lights, etc. can be used when manufactured. String lights were used to make (form) the complete outline of the cats and “Cats' Heart Shape” Night Light. The color of white light was used for the cats, but any color can be used when manufactured. Red string lights were used to form the heart shape inside of the heart shape formed by the cats to add extra emphasis to the “Cats' Heart Shape”. This inner heart shape was fastened closely to the heart shape formed by the cats with tie wraps. The string lights used for the cats were fastened to plywood in my prototype with U shaped metal nails. Two holes were made in the plywood to allow the string lights to enter to the front and exit to the rear of the plywood. The dimensions 50″ (height) by 34¼″ (width across the tails) were used. Any dimensions can be used when manufactured. The “Cats' Heart Shape” Night Light is placed in a vertical position and turned on to be viewed.

Best Mode Contemplated. The best mode contemplated is to manufacture my “Cats' Heart Shape” Night Light in one or all of the following methods:

1) The “Cats' Heart Shape” Night Light is formed as described in this description with any light source (light emitting device) such as string lights, neon light tubing, fiber optics, Christmas lights, etc. and is fastened to a base with metal hooks, tie wraps, plastic clamps or glue. The base (of any accommodating shape) can be made out of materials such as wood or plastic. The base and “Cats' Heart Shape” Night Light can then be displayed on any wall in any room. This is most similar to my prototype “Cats' Heart Shape” Night Light and is my choice if the other two listed methods are not acceptable by the Patent and Trademark Office. The “Cats' Heart Shape” Night Light will be brought to market by establishing my own company or through contracting or licensing with existing companies that can quickly and efficiently manufacture and distribute my “Cats' Heart Shape” Night Light to retail stores. When manufactured the dimensions of the “Cats' Heart Shape” Night Light will vary. The form (outline) of the cats may be modified for the best marketable appearance determined, but the distinguishing feature of a heart shape formed by two cats with their lower bodies, paws and tails will remain. A second heart shape inside of the heart shape formed by the cats may or may not be added when manufactured. The space within the heart shape formed by the cats or the space within the second heart shape placed inside of the heart shape formed by the cats may or may not be made to support a photograph, clock, mirror or other feasible device.

2) Thin plastic or metal can be used as a supporting frame to form the “Cats' Heart Shape” Night Light as described in this description. A light source such as Christmas lights is closely attached to the plastic or metal outline with clear tie wraps. The “Cats' Heart Shape” Nigh Light is sized to any dimension to be displayed on a window using hooked suction cups to hold it in place. The “Cats' Heart Shape” Nigh Light can then be viewed from inside and outside of the window.

3) The “Cats' Heart Shape” Night Light is sized to any dimension and formed (as described in this description) using neon light tubing. The neon light tubing is connected to a base of any accommodating shape made out of materials such as wood or plastic. The base provides support to hold the “Cats' Heart Shape” Nigh Light in an upright position. The “Cats' Heart Shape” Nigh Light can then be placed in any room or window for viewing.

Disclosure of intention. If only one of the methods listed above can be accepted as the best method contemplated then my choice is number one (1). If and only if this is the case, I grant permission to the United States Patent and Trademark Office to line through the other two methods listed as numbers two (2) and three (3) and mark and initial them as “not applicable” or in terms and methods required by the United States Patent and Trademark Office. It should be known to all that I intend to manufacture (at a later date) my “Cats' Heart Shape” Night Light in any of the three methods listed and possibly other methods still to be determined.

1. What I claim as my invention is the process of taking any light emitting device and using it to make a form (outline) of two cats that are positioned together to form a heart shape with their lower bodies, paws and tails along with a secondary heart shape that is placed inside of the heart shape formed by the cats. The distinguishing (distinctive) feature of this invention is the heart shape formed by the two cats' lower bodies, paws and tails (each cat forms half of a heart shape that connects together) and is displayed to the human eye with a light emitting device. The complete form (outline) of two cats with a light emitting device includes the heart shape formed by the cats, the second heart shape inside of the heart shape formed by the cats, the cats sitting in a position staring at each other with their faces touching together around the mouth area and their paws touching which all together complete my invention that I claim to be original and call my “Cats' Heart Shape” Night Light. This paragraph in its entirety completes my claim.
